(19) United States
(12) Patent Application Publication
(10) Pub. No.: US 2024/0302852 A1
(43) Pub. Date: Sep. 12, 2024

(54) METHOD FOR OPERATING A VACUUM PUMP AND VACUUM PUMP

(71) Applicant: Leybold GmbH, Cologne (DE)

(72) Inventors: Holger Dietz, Cologne (DE); Alexander Kaiser, Cologne (DE); Daniel Reinhard, Cologne (DE)

(21) Appl. No.: 18/550,046

(22) PCT Filed: Mar. 11, 2022
(86) PCT No.: PCT/EP2022/056344

§ 371 Date: Sep. 11, 2023

(30) Foreign Application Priority Data
Mar. 12, 2021 (GB) 2103478.0

(51) Int. Cl. G05D 22/02

(52) U.S. Cl. CPC G05D 22/02

(57) ABSTRACT

Method for operating a vacuum pump wherein first the humidity in the vacuum pump and/or humidity of an environment of the vacuum pump is determined and if the determined humidity is above a pre-set threshold generating a control signal to control condensation reduction means for reduction of humidity within the vacuum pump and/or generating a warn signal.

### CROSS-REFERENCE OF RELATED APPLICATION

This application is a Section 371 National Stage Application of International Application No. PCT/EP2022/056344, filed Mar. 11, 2022, which is incorporated by reference in its entirety and published as WO 2022/189633 A1 on Sep. 15, 2022, the content of which is hereby incorporated by reference in its entirety and which claims priority of British Application No. GB2103478.0, filed Mar. 12, 2021.

### BACKGROUND

The present invention relates to a method for operating a vacuum pump and such a vacuum pump.

Vacuum pumps comprise a housing defining a pump chamber. A rotor shaft is disposed in the housing and rotatably supported by bearings, the rotor shaft is rotated by an electromotor and comprises at least one pump element interacting with a stator connected to the housing. By rotation of the rotor shaft a gaseous medium is conveyed from an inlet of the vacuum pump to an outlet.

When pumping gasses with a higher water content there is the risk that this water will condense within the vacuum pump in the areas with high pressure. This can damage parts of the pump in that for example materials can rust or the quality of the lubricating oil can deteriorate. Condensation needs to be therefore avoided. In particular, the interior of many dry vacuum pumps is made of materials, such as cast iron, that are subject to severe corrosion in the presence of water.

Thus, it is an object of the present invention to provide a method for operating vacuum pump and such a vacuum pump for avoiding condensation.

The discussion above is merely provided for general background information and is not intended to be used as an aid in determining the scope of the claimed subject matter. The claimed subject matter is not limited to implementations that solve any or all disadvantages noted in the background.

### SUMMARY

A solution is provided by a method for operating a vacuum pump according to claim 1 and further by a vacuum pump according to claim 8.

The method according to the present invention for operating a vacuum pump comprises the steps of:
determining the humidity in the vacuum pump and/or humidity of an environment of the vacuum pump; and
if the determined humidity is above a preset threshold generating a control signal to control condensation reduction means for reduction of humidity within the vacuum pump and/or generating a warning signal.

Accordingly, in a first step the humidity in the vacuum pump and in particular the water content of the conveyed gaseous medium is determined. Alternatively or additionally, the humidity of the environment of the vacuum pump, i.e. outside the vacuum pump, is determined. Alternatively or additionally, the difference of the humidity of the environment of the vacuum pump and the humidity of inside the vacuum pump is determined. In a second step, on the basis of the determined humidity, a control signal is generated if the determined humidity is above a preset threshold. By the control signal condensation reduction means of the vacuum pump are controlled. Thus, by the condensation reduction means, the pumped water vapor is diluted and thus the water partial pressure is lowered below the local vapor pressure in order to avoid condensation and/or by the condensation reduction means any condensed water within the vacuum pump is evaporated and removed from the system in a drying step. Thus, due to determining the humidity and generating a respective control signal in dependence on the preset threshold, a reliable operation of the vacuum pump is provided independent from the experience or judgement of the user of the vacuum pump.

Preferably, humidity is determined in the exhaust of the vacuum pump and/or in a last pump chamber in the order of the gas flow of the vacuum pump. Thus, humidity is determined in areas of high pressure, where usually condensation takes place. Thereby, humidity of the water vapor or conveyed gaseous medium is determined, wherein determining of the humidity takes place directly on site where condensation should be avoided.

Preferably, the condensation reduction means include a gas ballast which is opened by the control signal. In particular, if the humidity within the vacuum pump is determined and above a preset threshold, the gas ballast is opened in order to draw in dry air from the environment of the vacuum pump. In particular, the gas ballast is opened if the humidity within the vacuum pump is above the humidity of the environment of the vacuum pump. Then, the water vapor within the vacuum pump is diluted by the dry air of the environment by opening the ballast thereby avoiding condensation within the vacuum pump.

Preferably, by the control signal a gas ballast flow is controlled and in particular increased in dependence on the determined humidity within the vacuum pump. Thus, upon increasing humidity within the vacuum pump, a gas ballast flow is increased, thereby introducing dry air from the environment of the vacuum pump into the vacuum pump to dilute the water vapor and avoid condensation. Therein, preferably also the humidity of the environment of the vacuum pump is determined and the gas ballast flow is only increased if the humidity of the environment is below the humidity within the vacuum pump. Thus, a continuous adaption of the gas ballast flow to the humidity determined within the vacuum pump is performed in order to avoid condensation within the vacuum pump without unnecessary loss of performance of the vacuum pump.

Preferably, the condensation reduction means include a heating element, wherein by the control signal a heating temperature of a heating element of the vacuum pump is increased in order to evaporate already condensed water within the vacuum pump or the water partial pressure in order to avoid condensation. Alternatively or additionally, the condensation reduction means include a cooling element, wherein the cooling temperature of the cooling element of the vacuum pump is increased to increase the temperature, thereby similarly increasing the water partial pressure within the vacuum pump and avoiding condensation. This can be done by reducing the flow of any coolant such as air or water. Then, by operation, the temperature of the vacuum pump is increased due to decreased cooling effect.

Preferably, the condensation reduction include an inlet valve at the inlet and/or an outlet valve at the outlet of the vacuum pump, wherein upon shutdown of the vacuum pump, preferably before full stop of the vacuum pump, the control signal controls the inlet valve at the inlet and/or the outlet valve at the outlet to close. Thus, in particular if the humidity is determined in the environment of the vacuum pump and being above a preset threshold, the interior of the vacuum pump is sealed during stand-by, i.e. during nonoperation times, in order to avoid humid air from the environment to be introduced into the vacuum pump causing corrosion. Therein it is possible to foresee an inlet valve at the inlet or an outlet valve at the outlet. Alternatively, the inlet valve at the inlet together with the outlet valve at the outlet is combiningly implemented in order to securely enclose the interior of the vacuum pump.

Preferably, upon shutdown of the vacuum pump, the vacuum pump is kept running until the humidity within vacuum pump is below a second threshold or for a predetermined time. Thus, upon receiving a stop signal from a pump control or a user, operation of the vacuum pump is maintained for a certain time in order to remove any water vapor from the interior of the vacuum pump. Therein, in particular, the vacuum pump is kept running with an opened gas ballast in order to draw in dry air from the environment and dry the interior of the vacuum pump in order to avoid corrosion. In particular, the gas ballast is opened during shutdown only, if the humidity in the environment of the vacuum pump is determined to be below the humidity within the vacuum pump.

In a further aspect of the present invention a method for operating a vacuum pump and in particular for shutdown of a vacuum pump is provided, comprising the steps of:
receiving a stop signal in order to stop operation of the vacuum pump; opening the gas ballast; controlling the vacuum pump to keep running for a predetermined time in order to dry the interior of the vacuum pump; and after the predetermined time, stop operation of the vacuum pump and preferably close the gas ballast. Thus, operation of the vacuum pump is maintained until the humidity inside the vacuum pump is dried.

Preferably, the method is further built according to the features of the method described above.

In a further aspect of the present invention a vacuum pump is provided comprising a housing with an inlet and an outlet. A rotor shaft is disposed in the housing and rotated by a motor, in particular an electromotor. Therein, at least one pump element is connected to the rotor shaft and arranged in at least one pump chamber defined by the housing. A control unit connected to the vacuum pump is configured to control operation of the vacuum pump. Further, the vacuum pump comprises at least one humidity sensor connected to the control unit. Therein, by the humidity sensor the humidity within the vacuum pump and, in particular, within the last pump chamber is detected. Alternatively or additionally, the humidity of an environment of the vacuum pump, i.e. outside the vacuum pump, is detected. Further, in accordance to the present invention, the vacuum pump comprises condensation reduction means for reduction of condensation within the vacuum pump being connected to the control unit. Therein, the control unit is configured to acquire a humidity by the humidity sensor and control the condensation reduction means for reduction of condensation, if the acquired humidity is above a preset threshold. Thus, condensation within the vacuum pump is effectively avoided.

Preferably, the humidity sensor is arranged within the vacuum pump and even more preferably in the exhaust or at the last pump chamber. Alternatively or additionally, the humidity sensor is arranged outside of the vacuum pump to acquire the humidity of the environment.

Preferably, the condensation reduction means include a warning signal, wherein the control unit activates the warning signal if the acquired humidity is above a preset threshold. Thus, the warning signal indicates a user the risk of corrosion within the vacuum pump due to humid gas or water vapor being pumped.

Preferably, the condensation reduction means include a gas ballast valve, wherein the control unit controls the gas ballast valve to open if the determined humidity is above a preset threshold, wherein preferably a gas ballast flow is controlled in dependence on the determined humidity. Preferably, in addition, the humidity of the environment of the vacuum pump is determined and the gas ballast valve is only opened, if the humidity of the environment of the vacuum pump is below the humidity within the vacuum pump.

Preferably, the condensation reduction means include a heating element and/or a cooling element, wherein the control unit controls the temperature of the heating element and/or cooling element to increase, if the acquired humidity is above a preset threshold. Therein preferably the temperature is continuously increased in dependence on the acquired humidity. Thus, by increasing the temperature of the heating element and/or the cooling element partial pressure is increased and condensation within the vacuum pump is avoided.

Preferably, the condensation reduction means include an inlet valve arranged at the inlet of the vacuum pump wherein upon shutdown of the vacuum pump, the inlet valve is closed by the control unit. Additionally or alternatively, the condensation reduction means include an outlet valve arranged at the outlet of the vacuum pump, wherein upon shutdown of the vacuum pump, the outlet valve is closed. Thereby, by the inlet valve and outlet valve humid air of the environment of the vacuum pump is prevented to enter after the vacuum pump has stopped, thereby avoiding corrosion within the vacuum pump during non-operational times of the vacuum pump.

Preferably, upon shutdown of the vacuum pump, the control unit is configured to keep the vacuum pump running until the humidity within the vacuum pump is below a second threshold or for a predetermined time. Thus, by further pumping the gaseous medium by the vacuum pump, water vapor within the vacuum pump is reduced below the second threshold in order to avoid condensation.

Further, the vacuum pump is developed along the features of the above described methods. Similar, the above described methods may encompass features described above in connection with the vacuum pump.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows a schematic diagram of the vacuum pump.

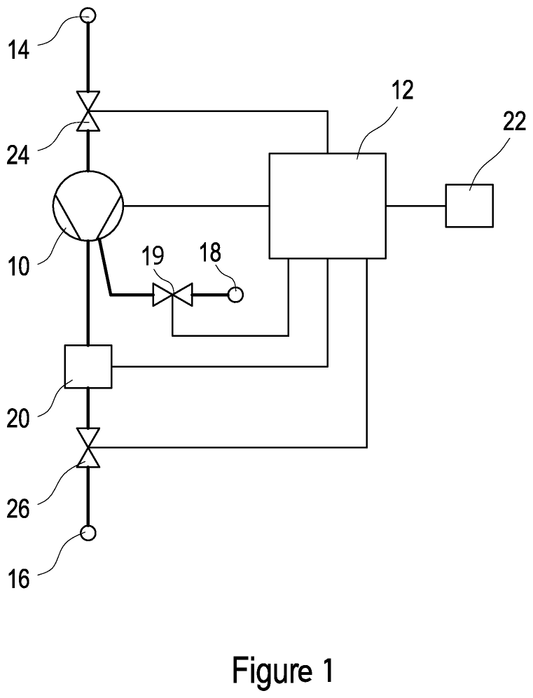

### DETAILED DESCRIPTION

Referring to the FIGURE, the vacuum pump 10 comprises an inlet 14 to be connected to a vacuum apparatus and an outlet 16 connected to the environment or a backing pump. Therein, the vacuum pump 10 is preferably a dry vacuum pump such as a scroll pump, screw pump or the like. The vacuum pump is connected to a control unit 12 in order to control operation of the vacuum pump 10. Further, in the exhaust towards the outlet 16 of the vacuum pump 10 a first humidity sensor 20 is arranged which is also connected to the control unit 12. By the first humidity sensor 20 humidity of the gaseous medium is detected. Similar, a second humidity sensor 22 may be arranged in the environment of the vacuum pump 10, detecting the humidity of the air in the environment, i.e. outside the vacuum pump 10. The second humidity sensor 22 is also connected to the control unit 12 of the vacuum pump 10.

The vacuum pump 10 comprises a gas ballast 18 which is controlled by a gas ballast valve 19 connected to the control unit 12. Further, an inlet valve 24 is connected to the inlet 14 of the vacuum pump 10 and also connected to the control unit 12 to be controlled by the control unit 12. Similar, an output valve 26 is arranged at the output 16 of the vacuum pump 10 also being connected to the control unit 12.

If by the first humidity sensor 20 in the exhaust of the vacuum pump 10 a humidity above a pre-set threshold is detected, the control unit 12 may generate a warning signal in order to warn the user of the vacuum pump that the humidity in the vacuum pump 10 is too high leading to the risk of condensation of the water vapor within the vacuum pump 10 causing corrosion and damage of parts of the vacuum pump 10.

Further, the control unit 12 may generate control signal to control one or more condensation reduction means for reduction of humidity within the vacuum pump, i.e. the gas ballast valve 19, the inlet valve 24, the outlet valve 26, a heating element and/or cooling element (not shown) connected to the vacuum pump, or the vacuum pump 10 itself.

If the detected humidity detected by the first humidity sensor 20 is above a pre-set threshold, the control unit 12 generates a control signal in order control the gas ballast valve 19 to open the gas ballast. In this case, air from outside the vacuum pump 10 is drawn into the vacuum pump thereby deluding the pumped water vapor and thus lower the water partial pressure below the local partial pressure in order to avoid condensation within the vacuum pump. Therein, the gas ballast flow can be controlled by the gas ballast valve 19 continuously in dependence on the measured humidity measured by the humidity sensor 20. Further, if the humidity detected by the second humidity sensor 22 of the environment of the vacuum pump 10 is above the humidity detected by the first humidity sensor 20 in the exhaust of the vacuum pump 10, the gas ballast valve 19 is not opened in order to avoid further accumulation of humidity within the vacuum pump 10.

Upon stopping or shutdown of the vacuum pump 10, i.e. receiving a stop signal in order to stop operation of the vacuum pump 10, the control unit 12 controls the vacuum pump 10 to keep running in order to transport the water vapor currently inside the vacuum pump 10 to the outlet 16, thereby drying the interior of the vacuum pump 10. This can be done until either the humidity detected by the first humidity sensor 20 at the exhaust of the vacuum pump 10 is below a second threshold or for a pre-set time. Further, during the drying process of keeping the vacuum pump 10 running the inlet valve 24 may be closed and/or the gas ballast valve 19 may be opened in order to draw in dry air from the environment of the vacuum pump. Therein, the gas ballast valve is not opened if the humidity in the environment of the vacuum pump detected by the second humidity sensor 22 is above the humidity within the vacuum pump 10. In this case, if the gas ballast valve 19 would be opened, further humidity would accumulate within the vacuum pump 10 counteracting the drying process of the interior of the vacuum pump 10.

If the humidity detected by the second humidity sensor 22 in the environment of the vacuum pump 10 is above a pre-set threshold upon stopping of the vacuum pump 10, the inlet valve 24 and/or the outlet valve 26 are closed in order to seal the interior of the vacuum pump 10 in order to avoid that moisture or humidity from the environment is drawn into the vacuum pump 10. Beforehand or at the same time, the gas ballast valve 19 is closed. Thus, during the time the vacuum pump is not running, i.e. non-operational times, the interior of the vacuum pump 10 is kept dry by closing the inlet valve 24 and the outlet valve 26, thereby avoiding corrosion of the interior of the vacuum pump 10.

Therein, the embodiment of the FIGURE discloses several different ways how to avoid condensation and accumulation of humidity within the vacuum pump which can be combined together or can be used individually. Therein, in an embodiment, if no gas ballast 18 is present, inlet valve 24 and/or outlet valve 26 might be present in order to avoid corrosion during non-operational times of the vacuum pump 10. In the same or another embodiment, the control unit 12 might be configured in order to control the vacuum pump 10 to keep running during the shutdown process in order to dry in the interior of the vacuum pump 10 before complete stop of the vacuum pump 10.

In an embodiment, the gas ballast 18 and the gas ballast valve 19 can be used without the inlet valve 24 and/or the outlet valve 26.

In an embodiment no second humidity sensor 22 is present in order to detect the humidity of the environment. In some embodiments only the second humidity sensor 22 to detect the humidity of the environment is present in order such that by the humidity detected by the second humidity sensor 22 the inlet valve 24 and/or the outlet valve 26 might be controlled. Similar, only the first humidity sensor 20 is present without the humidity sensor 22.

In an embodiment, the heating element and/or cooling element may be employed in order to avoid condensation. This can be done with or without gas ballast 18 and gas ballast valve 19. Similar, the heating element and/or cooling element can be freely combined with the inlet vale 24 and the outlet valve 26.

In an embodiment only a first humidity sensor 20 at the exhaust of the vacuum pump 10 is present, while the control unit 12 is only configured to keep the vacuum pump 10 running during shutdown process in order to dry the interior of the vacuum pump. Therein, in this embodiment there might be no gas ballast 18 and further no inlet valve and/or outlet valve 26.

Thus, the different condensation reduction means and detection of humidity can be freely combined in order to effectively avoid corrosion within the vacuum pump either by introducing dry air with the gas ballast 18, drying the interior of the vacuum pump 10 before complete stop of operation, adapting the temperature of the vacuum pump by adaption of the temperature of the heating element/cooling element or sealing the interior of the vacuum pump 10 by the inlet valve 24 and/or the outlet valve 26.

Although elements have been shown or described as separate embodiments above, portions of each embodiment may be combined with all or part of other embodiments described above.

Although the subject matter has been described in language specific to structural features and/or methodological acts, it is to be un-derstood that the subject matter defined in the appended claims is not necessarily limited to the specific features or acts described above. Rather, the specific features and acts described above are described as example forms of implementing the claims.

1. A method for operating a vacuum pump comprising the steps of:
Determining the humidity in the vacuum pump and/or humidity of an environment of the vacuum pump; and
if the determined humidity is above a preset threshold generating a control signal to control condensation reduction means for reduction of humidity within the vacuum pump and/or generating a warning signal.

2. The method according to claim 1, characterized in that the humidity is determined in the exhaust of the vacuum pump and/or in a last pump chamber of the vacuum pump.

3. The method according to claim 1, characterized in that the condensation reduction means include a gas ballast which is opened by the control signal.

4. The method according to claim 1, characterized in that by the control signal a gas ballast flow is increased preferably in dependence on the determined humidity.

5. The method according to claim 1, characterized in that the condensation reduction means include a heating element and/or a cooling element connected to the vacuum pump, wherein by the control signal a heating temperature of the heating element is increased and/or a cooling temperature of the cooling element is increased.

6. The method according to claim 1, characterized in that the condensation reduction means include an inlet valve at the inlet and/or an outlet valve at the outlet of the vacuum pump, wherein upon shutdown of the vacuum pump the control signal controls the inlet valve and/or the outlet valve to close.

7. The method according to claim 1, characterized in that upon shutdown of the vacuum pump, the vacuum pump is kept running for a predetermined time or until the humidity within the vacuum pump is below a second threshold.

8. A method for operating a vacuum pump comprising the steps of:
receiving a stop signal in order to stop operation of the vacuum pump;
opening the gas ballast;
controlling the vacuum pump to keep running for a predetermined time in order to transport the water vapor thereby drying the interior of the vacuum pump; and
after the predetermined time, stop operation of the vacuum pump and preferably closing the gas ballast.

9. A vacuum pump comprising
a housing with an inlet and an outlet,
a rotor shaft disposed in the housing rotated by a motor, wherein at least one pump element is connected to the rotor shaft and arranged in at least one pump chamber defined by the housing,
a control unit to control operation of the vacuum pump and
at least one humidity sensor connected to the control unit
characterized by
condensation reduction means for reduction of condensation within the vacuum pump connected to the control unit,
wherein the control unit is configured to determine a humidity by the humidity sensor and control the condensation reduction means for reduction of condensation within the vacuum pump if the acquired humidity is above a preset threshold.

10. The vacuum pump according to claim 9, characterized in that the humidity sensor is arrange within the vacuum pump, preferably in the exhaust or a last pump chamber and/or the humidity sensor is arranged outside of the vacuum pump to acquire the humidity of the environment.

11. The vacuum pump according to claim 9, characterized in that the condensation reduction means include a warning signal, wherein the control unit activates the warning signal if the determined humidity is above a preset threshold.

12. The vacuum pump according to claim 9, characterized in that the condensation reduction means include a gas ballast valve, wherein the control unit controls the gas ballast valve to open if the determined humidity is above a preset threshold, wherein preferably a gas ballast flow is controlled in dependence on the determined humidity.

13. The vacuum pump according to claim 9, characterized in that the condensation reduction means include a heating element and/or cooling element, wherein the control unit controls the temperature of the heating element and/or the cooling element to increase if the determined humidity is above a preset threshold, wherein preferably the temperature is increased in dependence on the acquired humidity.

14. The vacuum pump according to claim 9, characterized in that the condensation reduction means include an inlet valve and/or an outlet valve, wherein upon shutdown of the vacuum pump, the inlet valve and/or the outlet valve is closed.

15. The vacuum pump according to claim 9, characterized in that upon shutdown of the vacuum pump the control unit is configured to keep the vacuum pump running until the humidity within the vacuum pump is below a second threshold or for a pre-set time.
